(19) United States
(12) Patent Application Publication
(10) Pub. No.: US 2009/0182712 A1
(43) Pub. Date: Jul. 16, 2009

(54) Systems and methods for rapid delivery of media content

(76) Inventors: Faiza H. Kamal, Hewlett Harbor, NY (US); Simon McDonald, Zug (GB)

Correspondence Address: COVINGTON & BURLING, LLP;ATTN: PATENT DOCKETING, 1201 PENNSYLVANIA AVENUE, N.W., WASHINGTON, DC, 20004-2401, US

(21) Appl. No.: 12/007,804

(22) Filed: Jan. 15, 2008

(51) Int. Cl. G06F 17/30; G06F 7/00

(52) U.S. Cl. 707/3; 707/10; 707/E17.032; 707/E17.014

(57) ABSTRACT

In one embodiment of the present invention, a system is provided that includes at least one computer for receiving from a user a search query that includes at least one search term. A first portion of a set of data that includes the first portion and a second portion of data, is transmitted from a first source. The computer determines whether or not to transmit at least a portion of the set of data to the user from a second source based upon the presence of the at least one search term within only the second portion of the set of data.

### FIELD OF EMBODIMENTS OF THE INVENTION

Embodiments of the present invention generally relate to rapid delivery of media content via one or more networks and, more particularly, to rapidly searching and delivering at least headline information or data, pertaining to new stories and/or related media content, via one or more networks.

### BACKGROUND OF EMBODIMENTS OF THE INVENTION

The advent of modem computing and networking technologies has brought about an explosion of information that is becoming more and more available to the public. Widespread access to networks, such as the Internet, has fueled robust growth in demand for both media content and delivery channels which, in turn, has increased the desire for rapid access to targeted news and information.

The ability to quickly gather large amounts of news information and distribute relevant information to end-users may provide a competitive advantage to such end users. For example, providing financial news stories to end users in a rapid manner may enable end users to acquire and use this information before others can gain access to and react to the information.

There are known systems that have been utilized in efforts to rapidly provide information to end users. In one such system, a repository of news information is polled. In polling scheme or architecture, the text of the news story itself (e.g., story body) is searched, but the search is delayed by the duration of the polling interval. In such systems, decreasing the polling interval results in high system overhead and inefficiencies. Polling schemes do not scale well, and are thus not well-suited for a large client base.

Another architecture that has been utilized in an effort to rapidly provide news-related information to end users is a distributed system, where the news stories, perhaps emanating from multiple sources, are transmitted to each client and/or end user site. Distributed architectures generally have a high cost, as they require installation and maintenance of a client-side communication infrastructure that is capable of receiving and processing large volumes of data.

Aspects of the present invention are directed to providing rapid delivery of news content and news-related information to end-users in a manner that overcomes certain limitations associated with known systems and methods.

### SUMMARY OF EMBODIMENTS OF THE INVENTION

Embodiments of the present invention are generally directed to electronically transmitting news data to one or more end users. In one embodiment of the present invention, a method includes receiving via a network connection a set of news data that includes headline data, story data, and metadata. The headline data and the metadata are transmitted, from a first source, to a plurality of users. A search query that includes at least one search term is received from a user, and a determination is made whether or not to transmit the set of news data to the user from a second source based upon the presence of the at least one search term within only the story data of the set of news data.

In another embodiment of the present invention, a method includes receiving from a user a search query that includes at least one search term. A first portion of a set of data, is transmitted from a first source. The set of data includes the first portion and a second portion. A determination is made whether or not to transmit at least a portion of the set of data to the user from a second source based upon the presence of the at least one search term within only the second portion of the set of data. The first portion of data can include headline data and metadata, and the second portion of data can include a set of story data. The set of data can include a set of text data, and the set of text data can include a set of news data. More particularly, the set of text data can include financial data. Still further, the set of data can also include non-text data.

In still another embodiment, a system in accordance with an embodiment of the present invention can include at least one computer for receiving from a user a search query that includes at least one search term. The computer can transmit, from a first source, a first portion of a set of data. The set of data includes the first portion and a second portion of data. The computer also determines whether or not to transmit at least a portion of the set of data to the user from a second source based upon the presence of the at least one search term within only the second portion of the set of data.

In yet another embodiment, a system is provided that includes at least one computer for receiving from a user at least one user-provided search query, and receiving via a network connection news data that includes headline data, story data and metadata. The at least one computer uses the at least one user-provided search query to search the headline data, story data and metadata, and identify at least one of headline data, story data and metadata that satisfy the user-provided query. The at least one computer then transmits the headline data, but not the story data, to the user upon identifying at least one of headline data, story data and metadata that satisfy the user-provided query. The at least one computer may run or utilize software to accomplish or perform at least a portion of these tasks, functions or operations. In one embodiment of the present invention, the network may be or include the Internet.

The news data that is received via the network connection can be streamed. In addition, the headline data can be transmitted to the user via a network.

Searching the headline data, story data and metadata can take between approximately 20 milliseconds and 200 milliseconds for a news story. In addition, the system can include or utilize at least one computer that normalizes the news data which, in one or more embodiments of the present invention, can occur before the at least one computer uses the at least one user-provided search query to search the headline data, story data and metadata. Data normalization may take approximately 100 milliseconds or less.

One or more embodiments of the present invention can also include or utilize at least one computer that receives normalized news data and transmits the news data via a network to a client computer that determines which news data the user is entitled to view. The at least one computer that receives normalized news data can transmit the news data to the client computer within 2 milliseconds of receipt of the news data.

In still another embodiment of the present invention, the system may further include or utilize at least one repository computer that receives normalized news data and enables storage of the news data for subsequent searching. The at least one repository computer that receives normalized news data can store the news data within approximately 100 milliseconds of receipt of the news data.

In yet another embodiment of the present invention, a method includes receiving by at least one computer, via a network connection, news story data from a plurality of sources that include, for each news story, headline data, story data, and metadata. The format of the received news story data is normalized, and at least one search query from a user is received. The at least one computer uses the at least one search query to search the normalized news story headline data, story data and metadata, and identifies at least one of the headline data, story data and metadata that satisfy the search query. The at least one computer then transmits the headline data, but not the story data, to the user upon determining that at least one of the headline data, story data and metadata satisfy the search query. Identifying at least one of the headline data, story data and metadata that satisfy the search query can take between approximately 20 milliseconds and 200 milliseconds.

The received news story data can be streamed to the at least one computer and received and received by the at least one computer via a network connection. In addition, the headline data is transmitted to the user via a network.

Data normalization can occur prior to searching the news story headline data, story data and metadata. Normalization can take approximately 100 milliseconds or less.

In yet another embodiment of the invention, a computer program product residing on at least one computer readable medium is provided that includes instructions for causing a computer to receive from a user at least one search query, and receive via a network connection news story data that includes headline data, story data and metadata. The instructions also cause a computer to use the at least one search query to search the headline data, story data and metadata, and identify at least one of the headline data, story data and metadata that satisfy the search query. The instructions further cause the computer to transmit the headline data, but not the story data, to the user when it is determined that at least one of the headline data, story data and metadata satisfy the search query.

### BRIEF DESCRIPTION OF THE DRAWINGS

FIG. 1 is an exemplary block diagram illustrating aspects of a news story.

FIG. 2 is an exemplary block diagram that also serves as a flow diagram, illustrating aspects of news flow and operation of an embodiment of the invention.

FIG. 3 is an exemplary block diagram that also serves as a flow diagram, illustrating further aspects of news flow and operation of an embodiment of the invention.

FIG. 4 is an exemplary display of news search results displayed on a monitor.

### DESCRIPTION OF EMBODIMENTS OF THE INVENTION

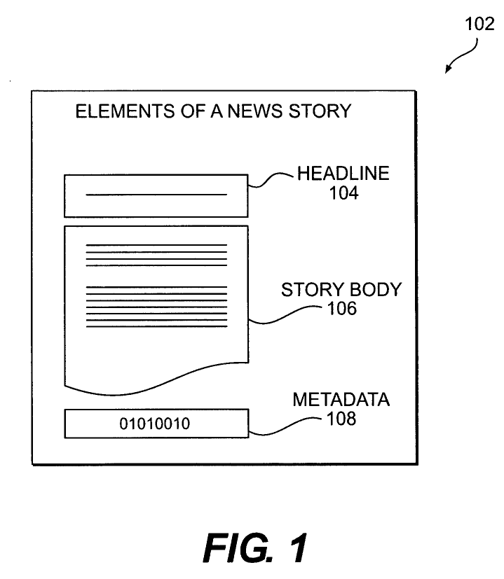

FIG. 1, generally at 100, is an exemplary block diagram illustrating aspects of a news story 102. A news story 102 can be provided from any number of sources, such as newspapers, magazines, professional journal articles, transcriptions of speeches, live proceeding or hearings, news conferences, and the like. A news story 102 can pertain or relate to any subject matter. For example, the news story could pertain or relate to business information, financial information, actual and/or expected corporate earnings, real estate information, personal finance information, tax planning information and/or strategies, investment opportunities, legal and/or regulatory developments, sports, and the like.

As shown, a news story 102 may include various elements, such as a headline 104, a story body 106, and metadata 108. Headline 104 includes the headline of a news story 102, and story body 106 includes the actual words (text) of the news story 102. Metadata 108 includes information about the news story 102, such as the number of words in the news story 102, the author of the news story 102, the time and date of transmission of the news story 102, the publication source (e.g., the New York Times, the Economist magazine, streamlined and/or transcribed text from a corporate earnings conference), and the originating source of the news story 102.

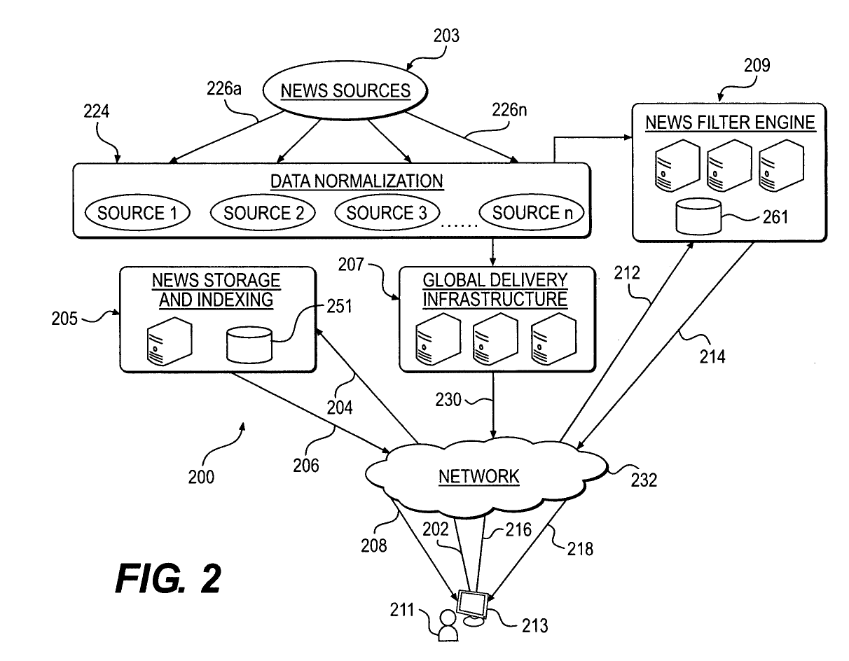

FIG. 2, generally at 200, is an exemplary block diagram that also serves as a flow diagram, illustrating aspects of news flow and operation of an embodiment of the invention. In operation, one or more end users 211 may use a general purpose computer 213 to formulate one or more standard search queries that are used to search for particular subject matter in news stories 102. In particular, in accordance with one aspect of the invention, a user 211 can formulate one or more search queries to search for text in one or more of the headline data 104, story body 106, or metadata 108. News stories 102 that can be transmitted to user 211 via network 232 may be historical, and contain stories that are up to several years old. In one embodiment of the present invention, news storage and indexing 205 can store news stories 102 that are up to approximately fifteen (15) months old. News stories 102 more than approximately fifteen months old or less than approximately fifteen months old can also be stored in (or by) news storage and indexing 205.

In addition, headlines from news stories 102 can be transmitted to an end user 211 upon the news story 102 being received by data normalization 224 and news filter engine 209. Data repository 261 associated with news filter engine 209 is used to store user 211 queries. In one embodiment of the present invention, news stories 102 are not stored in filter engine 209, but are instead searched by filter engine 209 in a transient manner. For example, data repository 261 can include a first section or portion of repository 261 for storing the portion of a user's 211 query pertaining to headline data 104 and metadata 108, and a second section or portion for storing a portion of a user's 211 query pertaining to story body data 106. The first sections (or portions) of repository 261 can by physically or logically separate. For example, two separate repositories 261 could be utilized, with a first repository 261a (not shown) used to store the portion of a user's 211 query pertaining to headline data 104 and metadata 108, and a second repository 261b (not shown) to store the portion of a user's 211 query pertaining to story data 106. Repository 261 could also have one or more logical sections that store the portion of a user's 211 query pertaining to headline data 104 and metadata 108, and one or more logical sections that store the portion of a user's 211 query pertaining to story body data 106. System 200 will transmit to user 211, via communication links 214, 218, the headline 104, but typically not the story body 106, of any news story (or stories) 102 that satisfy the user's 211 search query.

Embodiments of the present invention contemplate that the end user 211 can search for: i) real time headlines that are just being transmitted from news sources 203 to news filter engine 209; ii) historical data that is stored in news storage and indexing 205, or iii) both real time headlines 203 that are just being transmitted from news sources to news filter engine 209 and historical data that is stored in news storage and indexing 205. For each query formulated by the user 211 and stored in news filter engine 209, the user can specify whether s/he wishes to have news stories 102 returned in accordance with options i), ii) or iii). Data repository 261 associated with news filter engine 209 is used to store user queries. Depending on the user's 211 selection of options i), ii) or iii), the user's 211 search query can be stored in news storage and indexing 205 via communication links 202, 204, and/or be stored in news filter engine 209 via communication links 216, 212.

Data repository 251 associated with news storage and indexing 205 can include a first section or portion of repository 251 for storing headline data 104 and metadata 108, and a second section or portion for storing story body data 106. The first sections (or portions) of repository 251 can by physically or logically separate. For example, two separate repositories 251 could be utilized, with a first repository 251a (not shown) used to store headline data 104 and metadata 108, and a second repository 251b (not shown) to store story data 106. Repository 251 could also have one or more logical sections that store headline data 104 and metadata 108, and one or more logical sections that store story body data 106.

Whether user 211 wishes to search news storage and indexing 205, news filter engine 209, or both will depend on the user's subscription rights and the user's 211 query. For example, a given user 211 may not be granted access rights (e.g., by his company) or otherwise may not have an arrangement providing access to news storage and indexing 205. In such a case, the user will be only able to access news stories 102 using news filter engine 209. Of course, the same or a different user 211 may also only have access rights to news filter engine 209, and not have access right to (historical) news storage and indexing 205.

In one or more embodiments of the present invention, when a user 211 wishes to receive historical news story 102 data as well as real time news story 102 data, news storage and indexing 205 can operate in conjunction with news filter engine 209. For example, using computer 213, user 211 can formulate a search query that can be used to search for both historical news stories 102 that are stored and indexed in news storage and indexing 205 and real time news stories processed by news filter engine 209. In this embodiment, the user's 211 query can be transmitted by computer 213 via communication links 202, 204 for processing by news storage and indexing 205 which, and via communication links 216, 212 for processing by news filter engine 209. Upon processing the user's 211 query, historical news stories 102 in news storage and indexing 205 that satisfy the user's 211 query are transmitted, via network 232, to user 211 via communication links 206, 208. Similarly, real time news stories 102 received by news filter engine 209 that satisfy the user's 211 query are transmitted, via network 232, to user 211 via communication links 214, 218.

In addition, global delivery infrastructure 207 can be provided to transmit a collection of news stories 102 or other data to end users 211 apart from any user 211 query that is stored in news filter engine 209 and/or news storage and indexing 205. In one embodiment of the present invention, global delivery infrastructure 207 will transmit, via communication links 230, 218, news stories 102, or all of one or more subsets of news stories 102, to computer 213 which, in turn, has or has access to logic used to determine whether a particular user 211 is entitled to see any particular news story 102 that is received by computer 213. For example, suppose there are three users, 211a, 211b, and 211c (not shown), and three respective computers 213a-c (not shown) used by each user 211a-c. Suppose that all business news stories from Reuters, Associated Press, and Universal Press International are transmitted by global delivery infrastructure 207 to each registered user 211a-c. If user 213a has subscription rights to only Reuters business news stories 102, computer 213a, upon receiving the news stories 102 from each of Reuters, Associated Press, and Universal Press International, will “drop” the business news stories 102 from the Associated Press, and Universal Press International, so that user 211a does not see them. Similarly, if user 213b has subscription rights to only Reuters and Associated Press business news stories 102, computer 213b, upon receiving the news stories 102 from each of Reuters, Associated Press, and Universal Press International, will “drop” the business news stories 102 from Universal Press International, so that user 211b does not see them. Finally, by way of example, if user 213c has subscription rights to only Reuters and Universal Press International business news stories 102, computer 213c, upon receiving the news stories 102 from each of Reuters, Associated Press, and Universal Press International, will “drop” the business news stories 102 from Associated Press, so that user 211c does not see them. News stories 102 can also be delivered or dropped based, for example, on the publication source (e.g., Wall Street Journal, or Financial Times, etc.) of the news story 102.

News sources 203 will typically provide news stories 102 to data normalization 224 from approximately one hundred different sources. For example, news sources 203 will typically receive and transmit news stories 102 from each news source (e.g., Associated Press, Reuters, United Press International (UPI)) using a dedicated process, communication link, and/or thread 226a-n. In addition, one or more of any particular news source(s) 203 can transmit any number of new stories 102 at any instant in time. For example, UPI may be transmitting, for example, five, ten, twenty, fifty, or more, news stories 102 from news source 203 to data normalization 224 at any point in time. At the same instant (or range) of time, Associated Press and/or Reuters may also be transmitting, for example, five, ten, twenty, fifty, or more, news stories 102 from news source 203 to data normalization 224 at any point in time. Communication links 226a-n represent a plurality of communication links that may be used to receive news stories from a plurality of news sources 203.

When system 200 receives news stories 102 from news sources 203, data normalization 224 takes place. Normally, news stories that are transmitted by news sources 203 are transmitted in a variety of formats. For example, one news source 203 provider (e.g., Associated Press) may include all metadata 106 in a single field, whereas another news source 203 provider (e.g., Reuters) may have separate data fields for metadata 106. As an example, Reuters may have separate, dedicated data fields for each of the number of words in the news story 102, the author of the news story 102, and the time and date of transmission of the news story 102. Accordingly, data normalization 224 takes place so that news storage and indexing 205, global delivery infrastructure 207, and news filter engine 209 receive and process data in a common format.

In one or more embodiments of the present invention, data normalization 224 can utilize one or more general purpose computers running the Unix operating system or the Linux AS4 operating system to receive the news data from news sources 203. In addition, one or more computers, such as one or more SunFire 6800 servers, can be used to perform data normalization 224. In conjunction with data normalization 224, there can be a plurality of front end processing computers that receive the news data from news sources 203 via communication links 226a-n. In one embodiment of the present invention, there can be approximately eleven (11) standard computers running SCO Unix or Linux AS4. In addition, communication links 226a-n can be running multiple protocols. For example, certain of communication links 226a-n may be using TCP/IP (Transmission Control Protocol/Internet Protocol), certain other of communication links may be utilizing FTP (File Transfer Protocol), and certain other communication links 226a-n may be utilizing an asynchronous communication protocol.

The computers used for data normalization 224 can run or utilize, for example, the Solaris 10 operating system, along with Sybase database software to store in a common format the news stories 102 received from the plurality of news sources 203. For each news story 102, the normalization process typically takes less than 100 milliseconds. In one or more embodiments of the present invention, data normalization 224 will have three processes or threads running for each received news story. One process or thread will be for news storage and indexing 205, a second thread will be for global-delivery infrastructure 207, and a third thread will be for news filter engine 209. In general, there will thus be three process or threads activated for each news story 102 transmitted to data normalization 224 from news sources 203. Thus, for example, if news sources 203 has just transmitted fifty (50) news stories 102 to data normalization 224, data normalization will initially be running 150 threads or processes in conjunction with processing these news stories 102.

As noted above, after data normalization 224, processing by news storage and indexing 205, global delivery infrastructure 207, and news filtering 209 takes place in parallel (or substantially in parallel). News storage and indexing 205 performs indexing, in a standard manner, on every word in every news story 102. Thus, every and any word that occurs in every news story 102 can be searched in a manner that will indicate that a particular word (or word) occurs in a particular news story 102. One or more IBM x260 servers running Linux AS4 operating system can be used to perform processing associated with news storage and indexing 205. SyBase software can also be used to perform the indexing.

In one or more embodiments of the present invention, news filter engine 209 can utilize one or more IBM eServer x366 computers (from IBM Corporation, Armonk, N.Y.). The x366 computers can run the Linux AS4 operating system, and also run FAST InStream® software (FAST, Oslo, Norway, and Needham, Mass.) to perform searching for news stories 102 that satisfy the user's 211 search query.

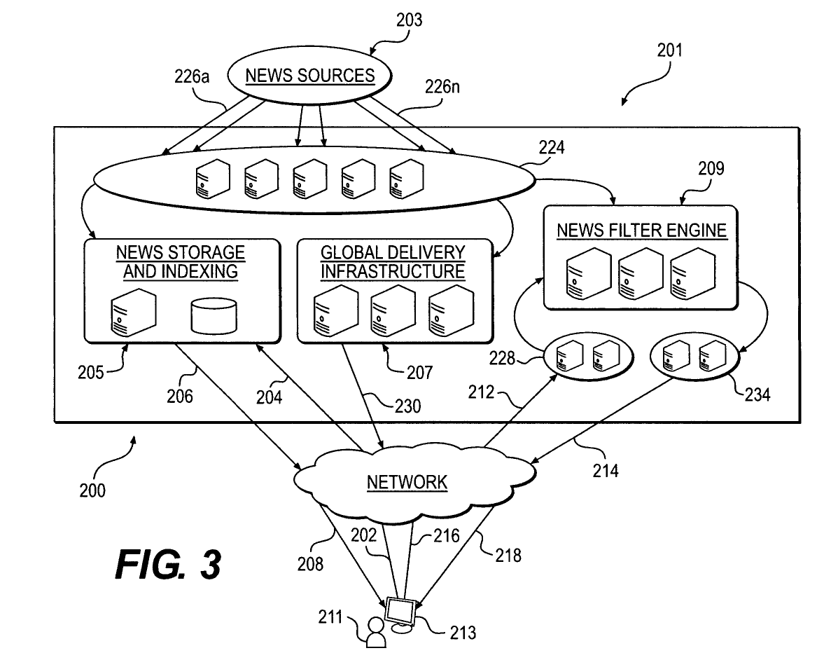

FIG. 3 is an exemplary block diagram that also serves as a flow diagram, illustrating further aspects of news flow and operation of an embodiment of the invention. In particular, FIG. 3 shows additional detail pertaining to data normalization 224, front end processing 228 and back end processing 234. In FIG. 3, data normalization 224 shows that there can be a plurality of computers, such as the previously mentioned general purpose computers running the Unix operating system or the Linux AS4 operating system and/or one or more SunFire 6800 servers, to receive the news data from news sources 203.

Front end processing 228 can be general purpose computers that perform function such as parsing the user's 211 query, and putting the user's 211 query info a standardized format for user by news filter engine 209. Front end processing 228 can also determine the user's 211 entitlement, ascertaining whether a particular user 211 has appropriate subscription rights to utilize and access new filter engine 209.

Back end processing 234 can include a general purpose computer running the Windows operating system. News filter engine 209 will transmit any news stories 102 that match or satisfy the user's 211 query to back end processing 234, which can format the query results for display on user's computer 213 for subsequent display to user 211 via communication links 214, 218 and network 232.

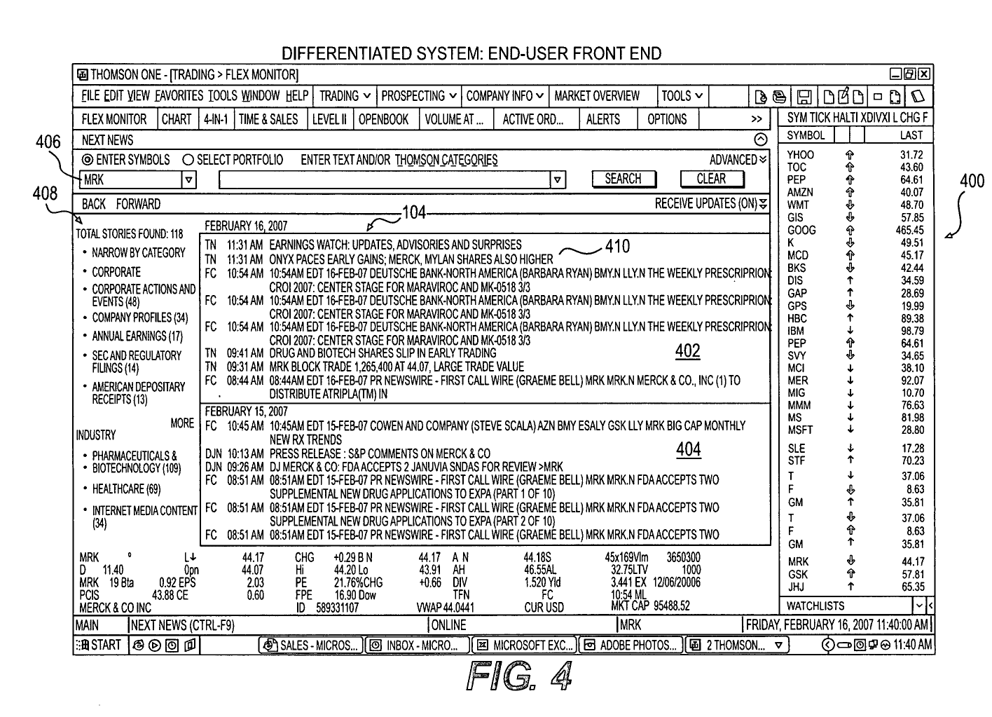

FIG. 4, generally at 400, is an exemplary display of news search results displayed an a monitor associated with computer 213. Regions 402, 404 of display 400 correspond to different dates on which a news story 102 is received by computer 213. As shown, region 402 corresponds to news stories that have been received and displayed on Feb. 16, 2007, and region 404 corresponds to news stories that have been received and displayed on Feb. 15, 2007. As is also shown, the time that a news story became publicly available (e.g., 11:31 AM, 11:31 AM, 10:54 AM, etc.) is also displayed, and the corresponding headline of the news story 102 (e.g., Earnings Watch: Updates, advisories and surprise, Onyx paces early gains; Merck, Mylan shares also higher, etc.). The searching for news stories 102 is performed and provided by news filter engine 209, which, as noted above, searched the headline 104, body text 106 and metadata 106 of a news story 102, and returns the headline 106, but not the story body 106, for display. As shown, metadata 108 such as the time of transmission of the news story 102, can also be displayed.

To obtain the headline 104 information, a user 211 can enter a search query, such as a stock ticker symbol, in field 406. As shown, the ticker symbol MRK is entered (for the Merck Corporation). As shown at 408, there have been 118 news stories that have been returned as of 11:31 AM on Feb. 16, 2007. As additional news stories 102 are transmitted by news sources 203 to system 200, the headlines 104, but not the story body 106, of such news stories 102 will also be displayed on display 400, for example, on a rolling basis. That is, display 400 is continuously updated with the headlines 106 of news stories 102 that satisfy the user's 211 query (e.g., the MRK query at 406).

The structures shown and discussed in embodiments of the invention are exemplary only and the functions performed by these structures may be performed by any number of structures. For example, certain functions may be performed by a single physical unit, or may be allocated across any number of different physical units. All such possible variations are within the scope and spirit of embodiments of the invention and the appended claims.

Embodiments of the present invention have been described for the purpose of illustration. Persons skilled in the art will recognize from this description that the described embodiments are not limiting, and may be practiced with modifications and alterations limited only by the spirit and scope of the appended claims which are intended to cover such modifications and alterations, so as to afford broad protection to the various embodiments of invention and their equivalents.

Having thus described my invention, what I claim as new and desire to secure by Letters Patent is as follows:

1. A method, comprising:
receiving via a network connection a set of news data comprising headline data, story data, and metadata;
transmitting, from a first source, the headline data and the metadata to a set of users;
receiving from a user in the set of users a search query comprising at least one search term; and
determining whether or not to transmit the set of news data to the user from a second source based upon the presence of the at least one search term within only the story data of the set of news data.

2. A method, comprising:
receiving from a user a search query comprising at least one search term;
transmitting, from a first source, a first portion of a set of data, the set of data comprising the first portion and a second portion;
determining whether or not to transmit at least a portion of the set of data to the user from a second source based upon the presence of the at least one search term within only the second portion of the set of data.

3. The method of claim 2 wherein the first portion comprises a headline and metadata and the second portion comprises a set of story data.

4. The method of claim 2 wherein the set of data comprises a set of text data.

5. The method of claim 4 wherein the set of text data comprises a set of news data.

6. The method of claim 4 wherein the set of text data comprises financial data.

7. The method of claim 4 wherein the set of data comprises non-text data.

8. A system, comprising:
at least one computer configured for
receiving from a user a search query comprising at least one search term;
transmitting, from a first source, a first portion of a set of data, the set of data comprising the first portion and a second portion; and
determining whether or not to transmit at least a portion of the set of data to the user from a second source based upon the presence of the at least one search term within only the second portion of the set of data.

9. A system, comprising:
at least one computer configured for
i) receiving from a user at least one user-provided search query;
ii) receiving via a network connection news data comprising headline data, story data and metadata;
iii) using the at least one user-provided search query to search the headline data, story data and metadata;
iv) identifying at least one of headline data, story data and metadata that satisfy the user-provided query; and
v) transmitting the headline data, but not the story data, to the user upon satisfying iv).

10. The system according to claim 8, wherein the news data received via the network connection is streamed.

11. The system according to claim 8, wherein the headline data is transmitted to the user via a network.

12. The system according to claim 1, wherein the network comprises the Internet.

13. The system according to claim 9, wherein the search takes between approximately 20 milliseconds and 200 milliseconds.

14. The system according to claim 13, wherein the at least one computer further normalizes the news data.

15. The system according to claim 13, further comprising at least one computer for normalizing the news data prior to iv).

16. The system according to claim 15, wherein the normalization takes approximately 100 milliseconds or less.

17. The system according to claim 9, wherein the computer comprises software for performing i)-v).

18. The system according to claim 9, further comprising at least one computer that receives normalized news data and transmits the news data via a network to a client computer that determines which news data the user is entitled to view.

19. The system according to claim 18, wherein the at least one computer that receives normalized news data transmits the news data within 2 milliseconds of receipt of the news data.

20. The system according to claim 9, further comprising at least one repository computer that receives normalized news data and enables storage of the news data for subsequent searching.

21. The system according to claim 20, wherein the at least one repository computer that receives normalized news data stores the news data within 100 milliseconds of receipt of the news data.

22. A method, comprising:
i) receiving by at least one computer via a network connection news story data, from a plurality of sources comprising, for each news story, headline data, story data and metadata;
ii) normalizing a format of the received news story data;
iii) receiving from a user at least one search query;
iv) using the at least one search query to search the normalized news story headline data, story data and metadata;
v) identifying at least one of the headline data, story data and metadata that satisfy the search query; and
vi) transmitting the headline data, but not the story data, to the user upon satisfying v).

23. The method according to claim 22, wherein the news story data is streamed news data received via a network connection.

24. The method according to claim 22, wherein the headline data is transmitted to the user via a network.

25. The method according to claim 22, wherein v) takes between approximately 20 milliseconds and 200 milliseconds.

26. The method according to claim 22 wherein the normalization occurs prior to iv).

27. The method according to claim 26, wherein the normalization takes approximately 100 milliseconds or less.

28. A computer program product residing on at least one computer readable medium, comprising instructions for causing a computer to:
i) receive from a user at least one search query;
ii) receive via a network connection news story data comprising headline data, story data and metadata;
iii) use the at least one search query to search the headline data, story data and metadata;
iv) identify at least one of the headline data, story data and metadata that satisfy the search query; and
v) transmit the headline data, but not the story data, to the user upon satisfying iv).
